(19) United States
(12) Patent Application Publication
(10) Pub. No.: US 2013/0250104 A1
(43) Pub. Date: Sep. 26, 2013

(54) LOW COST SATELLITE IMAGING METHOD CALIBRATED BY CORRELATION TO LANDSAT DATA

(71) Applicant: Darrel Leon WILLIAMS, Bowie, MD (US)

(72) Inventor: Darrel Leon WILLIAMS, Bowie, MD (US)

(73) Assignee: GLOBAL SCIENCE & TECHNOLOGY, INC, Greenbelt, MD (US)

(21) Appl. No.: 13/424,605

(22) Filed: Mar. 20, 2012

(51) Int. Cl. H04N 7/18

(52) U.S. Cl. 348/144; 348/E07.085

(57) ABSTRACT

A method for augmenting Landsat-based image data providing a satellite at an orbital altitude lower than an orbital altitude of a Landsat imaging satellite; providing a set of multispectral imaging devices arranged on the satellite configured to image a terrestrial swath larger than a standard Landsat image swath, configured to always image when orbiting over cloud-free terrestrial surfaces and descending node defined along a northeast to southwest trajectory so as to correspond to Landsat archive data; synchronizing image data from at least four visible bands and a near-infrared band with a first resolution with image data from a shortwave infrared band with a second resolution; retracing the imaged terrestrial swath for one or more iterations; downlinking image data to a ground station being formatted in accordance with a data format; compositing the synchronized image data to create a cloud-free image and periodically cross-calibrating it with Landsat-based image data.

### BACKGROUND

This disclosure relates to a system and method for satellite imaging, particularly to systems and methods for terrestrial imaging which augment existing Land Remote-Sensing Satellite (“Landsat”) imaging using low-cost techniques calibrated by correlation to archived Landsat data.

Landsat images have been used to document land cover and land use change since 1972, spanning a period when global populations have more than doubled, and associated land transformations have increased at an escalating rate. This nearly 40-year Landsat global archive constitutes perhaps the most valuable global change/climate data record available to the world. In late 2008, the U.S. Geological Survey (USGS) Earth Resources Observation and Science (EROS) Center implemented a decision to make their deep archive of Landsat imagery available to the world community free of charge. In less than two years following that implementation of a free data policy, well over three million scenes have been downloaded and analyzed by thousands of users from 186 different countries. A bulk of the resulting image analyses has been focused on using the Landsat archive for inter-annual assessments to monitor change over time. The often dramatic change detection results have served to heighten interest in not only maintaining the continuity of Landsat imaging, but in increasing the temporal repeat frequency to obtain more robust “within season” assessment capability. The scientific utility of dramatically improved temporal repeat coverage, permitting scientists to assess the nuances of within season fluctuations in productivity at 30 m resolution, anywhere on the globe, is clearly breathtaking Sadly, the prospect of maintaining, let alone improving upon, the 8-day temporal repeat coverage provided by Landsat's 5 and 7 over the last decade will be hard to realize due to the escalating production costs associated with building these high precision missions (e.g., ˜US$1B each). There is a need to look for dramatically lower cost options to augment, but not replace, the classic Landsat missions.

In addition, an understanding of vegetation dynamics requires characterization of within-year seasonality at “field scale” resolution of 30 m visual, near infrared (VNIR) and short-wave infrared (SWIR) imagery, ideally with clear views once per week. However, Landsat's 16-day revisit translates to annual mapping, at best, for much of the globe. For example, with two Landsat's in orbit for about the last 13 years, it still takes 3-5 years to create a cloud-free global data set. Such sporadic mapping cannot support applications that require more frequent observations at Landsat's field scale, e.g., agricultural monitoring for global food security, or for monitoring the impact of natural disasters such as tornadoes and tsunamis.

The scientific community has recognized the trade offs between having acceptable quality data available all the time, rather than having high precision data sets that might have coverage gaps. This reality has been referred to as a “Landsat data gap.”

What is needed is a system and method for acquiring scientifically-valid imagery more frequently than Landsat data via a low cost solution. What is also needed is a system and method that obtains daily temporal repetition to create a cloud-free mosaic data sets at “field scale” 30 m resolution. What is further needed is an imaging system and method that meets the above needs, and satisfactorily fills the Landsat data gap in a cost-effective manner.

### SUMMARY

In one or more embodiments, a low-cost, small-sat Landsat-like imaging system and method is disclosed which achieves a cost-effective alternative solution that can provide imagery of sufficient quality and quantity to augment global Landsat coverage. Such an approach reduces project costs to be as much as an order of magnitude less expensive than a typical “gold standard” Landsat mission in the current aerospace environment. Embodiments of this disclosure provide a mission concept that provides dramatically enhanced scientific and humanitarian applications, with reduced risk of a devastating gap in Landsat-like imaging capability.

Embodiments of this disclosure draw from lessons learned from previous Landsat missions and other satellite imaging systems, and which are responsive to needs repeatedly expressed in numerous government report from various organizations with respect to the critical need for datasets at 30 m field scale to support a wide variety of scientific, strategic, humanitarian, and commercial applications.

Implementation of the inventive concept described herein with respect to the Terrestrial Ecosystem Dynamics (TerEDyn) system and method will provide data needed to significantly improve understanding of terrestrial ecosystems productivity and how humans affect this productivity. In one or more embodiments, the basis of this improvement is as follows: TerEDyn will fill a long recognized data gap by providing global sub-monthly cloud-cleared surface reflectance data sets at 30 m resolution. The data will support global studies of land dynamics at the field scale and temporal resolution enabling analysis of land intra- and inter-annual dynamics. TerEDyn combines the best attributes of Moderate Resolution Imaging Spectroradiometer (MODIS) and Landsat while serving as a pathfinder that could lead to a constellation of low-cost observatories that overcome the spatial limitations of MODIS and the temporal limitations of Landsat.

In one or more embodiments, the TerEDyn observatory may include 5 spectral bands, 10-bit radiometry and use of onboard data compression. This sensor spectro-radiometric configuration will achieve necessary scientific objectives and enable acquisition of sufficient imagery to produce sub-monthly cloud-cleared composites needed to support these objectives. These steps have been taken to ensure that the anticipated data volumes can be more easily downloaded and processed, while ensuring quality observations needed to address the science goals of this mission. The TerEDyn mission is positioned in the land imaging trade space (i.e. spectral, spatial, radiometric, temporal) between the new Landsat Data Continuity Mission (LDCM) Operational Land Imager (OLI) instrument and the MODIS land measurements, aimed at achieving the data acquisition goals that neither of these other land observatories will be able to accomplish, even when combined in analyses.

There is a fifth dimension of satellite land imaging trade space—rarely mentioned in scientific discussions—the cost trade space. The total cost of the initial TerEDyn mission is expected to be less than $150 million, while subsequent per unit costs are estimated to cost less than half this amount.

In one or more embodiments, the TerEDyn observatory will be acquiring global land coverage on a 8-day repeat cycle at the equator, providing 4 observations per month in these locations. At mid-latitudes this coverage improves to 4-6 day repeat with nearly daily repeat coverage in the polar regions. Note that as growing season length decreases toward the poles, the achievable repeat coverage improves. It is anticipated that, for most land areas, sub-monthly, mostly cloud-free composites will be possible using an Always Acquire Over sunlit Land (“AAOL”) global acquisition strategy.

In one or more embodiments, the data stream for the mission will be collected and forwarded to USGS EROS Center, which will archive the Level 0 (raw) data, and produce the Levels 1G and 1T products. Level 0 data products are reconstructed, unprocessed instrument/payload data at full resolution; any and all communications artifacts, e.g. synchronization frames, communications headers, with duplicate data removed. Level 1A data products are reconstructed, unprocessed instrument data at full resolution, time-referenced, and annotated with ancillary information, including radiometric and geometric calibration coefficients and georeferencing parameters, e.g., platform ephemeric, computed and appended but not applied to the Level 0 data. The Level 1T products will be forwarded to the NASA Earth Exchange (NEX) computing facility where the remainder of the data processing and scientific analyses will take place.

In one or more embodiments, TerEDyn will allow for dramatically improved estimates of photosynthesis (Ps) and land use at spatial and temporal resolutions that capture the global and regional patterns of human activity. Given the high spatial and temporal resolution of TerEDyn, it is possible, for example, to differentiate irrigated and rain fed agriculture, helping document the degree to which humans are expanding the biological productivity of the planet.

In one or more embodiments, a range of data products may be produced using the robust TerEDyn data stream obtained from original sensor observations to summary analyses of the role of human activities in primary productive allocation.

In one or more embodiments TerEDyn compiles sub-monthly “cloud-cleared” composites of surface spectral reflectance. To achieve primary measurement objectives, artifacts in the original observations that disrupt extraction of desired land surface measurements must be removed as much as possible. Details of the preprocessing steps to be carried out are discussed below.

In accordance with an embodiment, a method for augmenting Landsat-based image data includes providing a satellite at an orbital altitude lower than an orbital altitude of a Landsat imaging satellite; providing a set of multispectral imaging devices arranged on the satellite, said set of multispectral imaging devices configured to image a terrestrial swath larger than a standard Landsat image swath, said set of multispectral imaging devices being configured to always image when orbiting over cloud-free terrestrial surfaces and to image on a descending node defined along a northeast to southwest trajectory so as to correspond to Landsat archive data; synchronizing image data from at least four visible bands and a near-infrared band with 15 meter resolution with image data from a shortwave infrared band with 30 meter resolution; retracing the imaged terrestrial swath for one or more iterations; downlinking image data to a ground station, the downlinked image data being formatted in accordance with a Consultative Committee for Space Data Systems (CCSDS) data format; compositing the synchronized image data to create a cloud-free image; and periodically cross-calibrating the composited image data with Landsat-based image data.

In another embodiment, a method for earth imaging includes providing a satellite at an orbital altitude that underflies an orbital altitude of a Landsat imaging satellite; providing a set of multispectral imagers arranged on the satellite and covering a first plurality of visible bands and a second plurality of infrared bands that image a ground swath; said first plurality of visible bands being imaged at a first resolution, and at least one of the second plurality of infrared bands being imaged at a second resolution different from the first resolution, synchronizing image data from the first plurality of visible bands and a near infrared band with the first resolution with image data from the shortwave infrared band with the second resolution; and downlinking image data to a ground station.

### BRIEF DESCRIPTION OF THE DRAWINGS

Various embodiments of this disclosure will now be described with reference to the drawings in which:

FIG. 1 illustrates a process or method for providing earth imaging data and complementing Landsat data in accordance with an embodiment;

FIG. 2 provides an exemplary illustration of satellite earth track of an embodiment in comparison to a Landsat track;

FIG. 3 provides an illustration of a satellite downlink arrangement according to an embodiment

FIG. 4 illustrates achieving more frequent coverage at 30 m resolution to yield enhanced probability of generating cloud-cleared or cloud-free views;

FIG. 5 illustrates an example of a cloud-cleared monthly 30 m composite product for the lower 48 states generated using only Landsat 7's 16-day repeat coverage;

FIG. 6 illustrates an example of a Web-Enables Landsat Data (WELD) cloud-cleared monthly 30 m global composite product generated using only Landsat 7 16-day repeat coverage;

FIG. 7A illustrates an embodiment of the TerEDyn spacecraft and instrument concept and tabular summaries of key characteristics;

FIG. 7B illustrates an enlarged ray tracing of wavelength paths for the instrument of FIG. 7A; and

FIG. 8 illustrates an exemplary ground segment according to an embodiment.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

The Terrestrial Ecosystem Dynamics mission concept (“TerEDyn”) mission concept is targeted at augmenting—not replacing—Landsat coverage with more frequent temporal repeat coverage at 30 m in telemetry (TM) bands 1-5. TerEDyn's global imaging strategy is to be “always on” when passing over land during daylight hours, thereby yielding an unprecedented combination of spatial and temporal resolution for monitoring land surface dynamics. TerEDyn data can be made available via standard user interface protocols at the United States Geological Survey (USGS) Earth Resources Observation and Science (EROS) Center. TerEDyn is an innovative multispectral Earth observation smallsat mission designed to augment Landsat by providing more frequent global temporal repeat coverage. TerEDyn is both low-risk and low-cost because it takes advantage of proven, high-heritage components in the instrument, spacecraft, and ground segments, arranged and processed in a novel way.

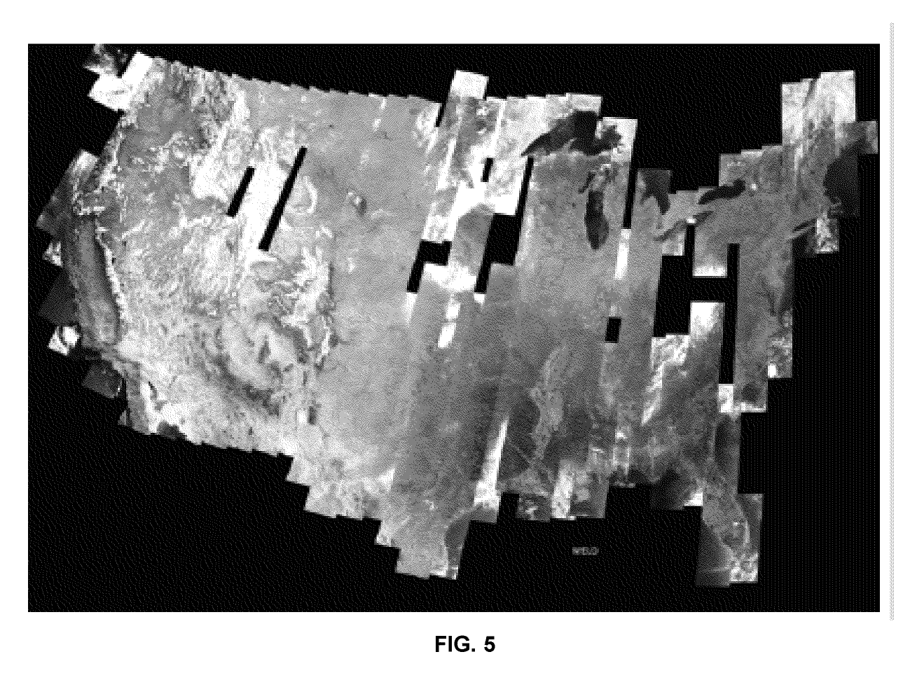

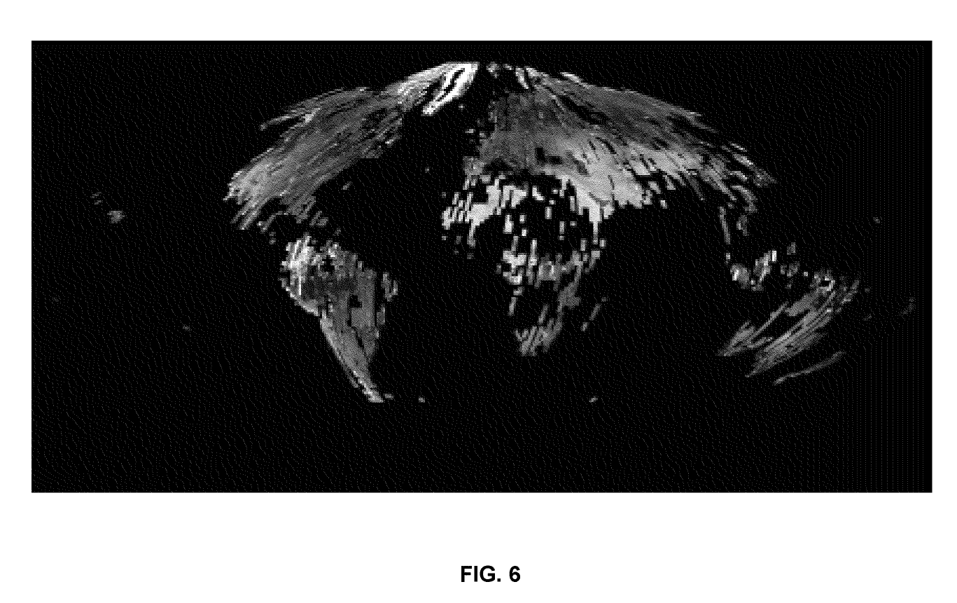

TerEDyn combines the best attributes of MODIS (frequent, global coverage) and Landsat (30 m resolution in TM bands 1-5, i.e., including SWIR) missions while serving as a demonstration/pathfinder mission that could lead to a constellation of low-cost observatories that would overcome the spatial limitations of MODIS and the temporal limitations of Landsat. TerEDyn is positioned in the land imaging trade space (i.e., spectral, spatial, radiometric, and temporal resolution) between the new Landsat Data Continuity Mission Operational Land Imager (OLI) and MODIS land measurements, and is aimed at achieving science goals that data from neither of these land observatories accomplishes even when combined in analyses. In an embodiment, TerEDyn fills a long recognized data gap by providing global sub-monthly cloud-cleared surface reflectance data sets at 30 m resolution (see FIGS. 5 and 6). TerEDyn's cloud-cleared data sets and higher-level products are expected to have tremendous utility for scientific, strategic, commercial and humanitarian applications such as providing the data needed to answer the question “How are terrestrial ecosystems changing as affected by human activities and natural events?”

There is another dimension of the satellite land imaging trade space that is rarely mentioned in scientific and user discussions, and that is the cost of the missions. The total cost of the proposed TerEDyn mission is estimated to be less than $150 million, including launch and several years of on-orbit operations. Subsequent clone copies of TerEDyn built under private industry best practices could cost less than half as much and, therefore, would be within a cost range of affordability for both private industry and other nations. A constellation consisting of a total five TerEDyn clones would yield global daily coverage at 30 m spatial resolution.

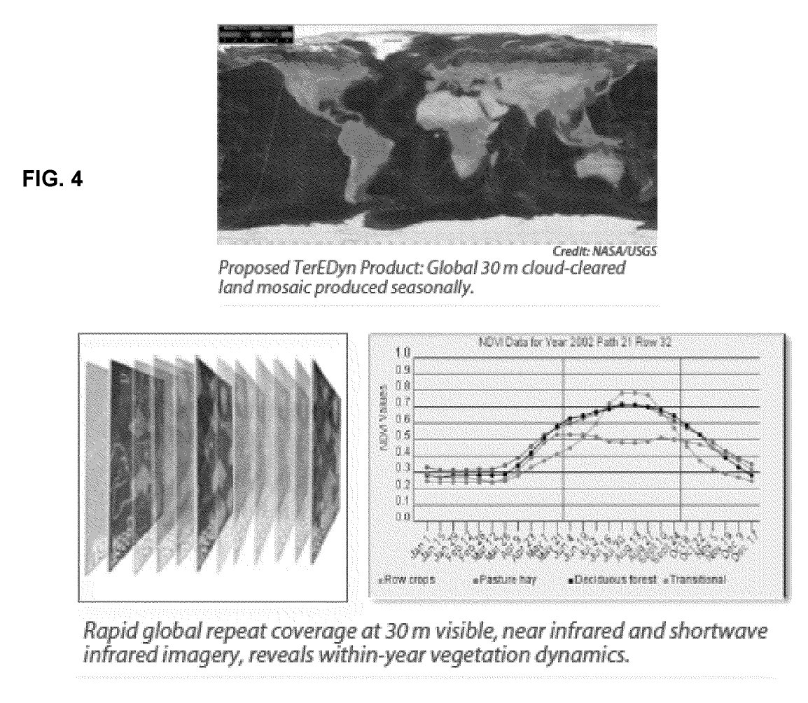

A key data product stemming from the TerEDyn mission is the production of orthorectified, sub-monthly composited, cloud-cleared surface spectral reflectance measurements using the Web-Enabled Landsat Data (WELD) approach developed recently by Dr. David Roy of South Dakota State University (SDSU). Orthorectification is processing an aerial photograph to geometrically correct it so that the scale of the photograph is uniform and it can be measured in the same way as a map is. With its 390 km swath width imager, TerEDyn will acquire complete global land coverage on an 8-day repeat cycle at the equator. At mid-latitudes, this coverage improves to a 4-6 day repeat, while near-daily coverage is acquired in the high-latitude polar regions. Since the TerEDyn imager will be operated as “always on” over illuminated land, this robust imaging approach will result in the acquisition of 4×-5× the amount of daily imagery ever collected by any previous Landsat mission. FIG. 4 illustrates how more frequent coverage at 30 m resolution will yield enhanced probability of generating cloud-cleared views, leading to better understanding of terrestrial ecosystem dynamics.

In FIG. 5, an example of a cloud-cleared monthly 30 m composite product for the lower 48 states generated using only Landsat 7's 16-day repeat coverage is illustrated. FIG. 5 is an example of a WELD cloud-cleared monthly 30 m composite for July 2008 generated only using images acquired during Landsat 7's 16-day repeat cycle. TerEDyn's more robust and more frequent repeat coverage is expected to yield mostly cloud-free monthly data sets as well as sub-monthly (bi-weekly) data sets that are predominantly cloud-free. Sub-monthly composites of TerEDyn data will allow users to incorporate seasonal dynamics in land cover conditions at 30 m into their analyses using methods pioneered with seasonal data from coarser resolution sensors such as Advanced Very High Resolution Radiometer (AVHRR) and MODIS. TerEDyn will collect 4×-5× as much data per month than Landsat; therefore, the expectation is that complete, nearly cloud-free monthly mosaics will be possible almost anywhere on Earth. Plans also call for generation of best available bi-weekly composites.

FIG. 6 is an example of a global WELD cloud-cleared monthly 30 m composite for July 2010 based only on acquisitions stemming from Landsat 7's 16-day repeat cycle. The product was generated using 6500 Landsat 7 scenes by implementing WELD processes within the NASA Ames NEX computing environment. The missing land areas are areas where cloud cover was greater than 40% and/or the data were missing from the USGS EROS archive. TerEDyn's robust “always on” image acquisition plan, coupled with its 390 km swath and 8-day (about 1 week) repeat coverage, is expected to provide enough additional imagery to routinely fill in all of the blanks that exist in this example monthly global product. Since TerEDyn will collect 4×-5× as much data per month as Landsat, the expectation is that more complete, nearly cloud-free monthly global mosaics will be possible. Plans also call for generation of best available bi-weekly composites on a continental/regional basis.

TerEDyn is innovative in that it employs a streamlined, low-risk development approach featuring proven fixed price build processes for already proven instrument and spacecraft designs. The commercial marketplace was reviewed to identify already available high heritage platforms and sensors that might yield, with minimal modifications, significant Earth science breakthroughs. This resulted in the selection of various system hardware components.

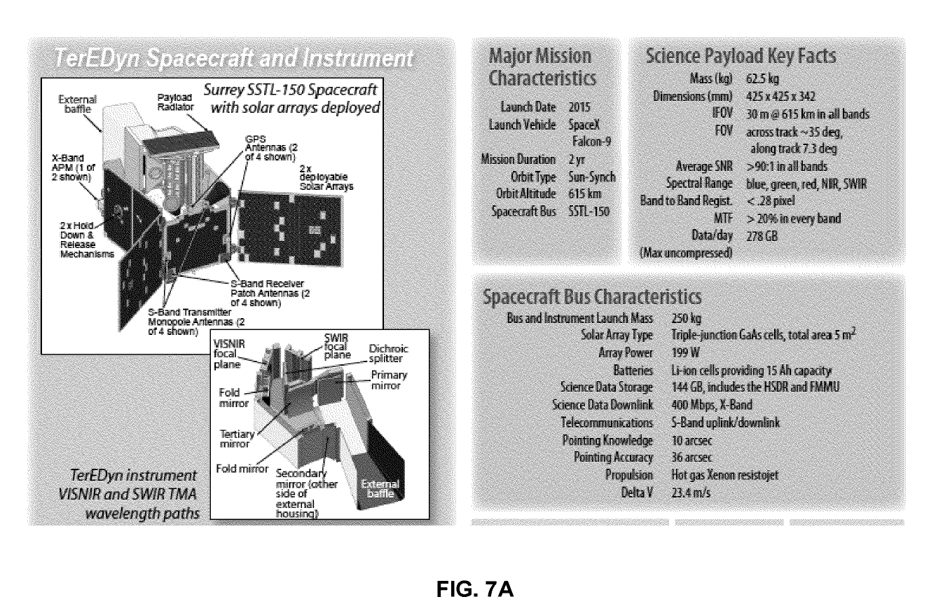

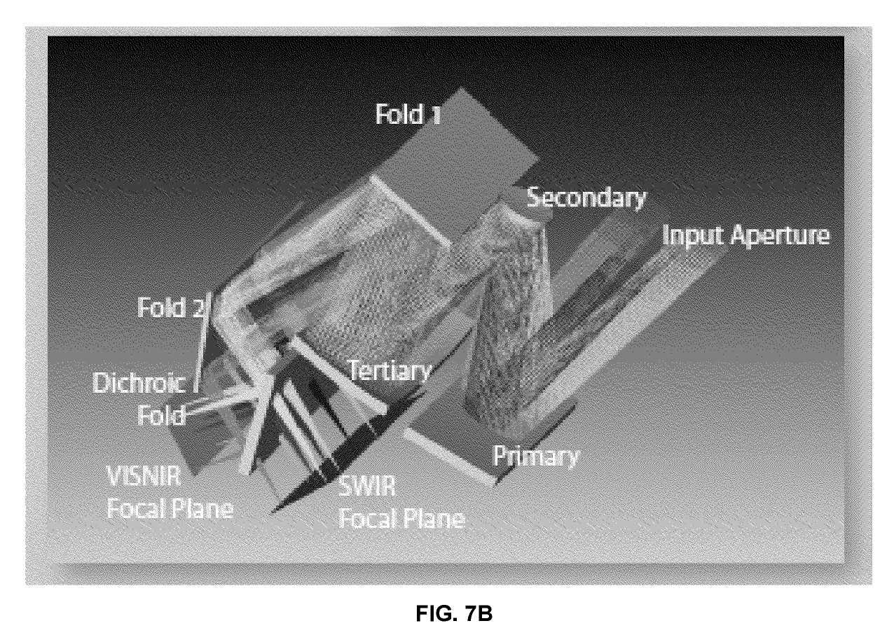

An exemplary embodiment of a TerEDyn spacecraft and instrument characteristics are summarized in FIG. 7A, which includes a tabular summary of key characteristics. FIG. 7B illustrates an enlarged ray tracing of wavelength paths for the instrument in FIG. 7A. Table 1 below summarizes exemplary performance data for the TerEDyn system which has been derived by analysis of the Landsat data gap.

TABLE 1
Baseline Performance Specifications from Landsat Data Gap Study Team

| Performance | Performance Goal: | Baseline | |
|---|---|---|---|
| Parameter | LDCM Specification | Specification | TerEDyn Solution |
| Spectral Bands | Blue1: 430-450 nm | Green: 525-600 nm | Blue1: 430-450 nm |
| | Blue: 450-520 | Red: 630-680 nm | Blue: 450-520 nm |
| | Green: 525-600 nm | NIR: 845-885 nm | Green: 530-600 nm |
| | Red: 630-680 nm | SWIR (1): 1560-1660 nm | Red: 630-680 nm |
| | NIR: 845-885 nm | | NIR: 850-890 nm3 |
| | SWIR (1): 1560-1660 nm | | SWIR(1): 1560-1660 nm |
| | SWIR (2): 2100-2300 nm | | SWIR(2): 2100-2300 nm |
| Radiometry | <5% error in at-sensor | <15% error in at- | <5% error in at-sensor |
| | radiance, linearly | sensor radiance, | radiance, linearly scaled |
| | scaled to image data | linearly scaled to | |
| | | image data | |
| Spatial | 30 m GSD VNIR- | 10-100 m GSD | 30 m VNIR*-SWIR; *all |
| Resolution | SWIR; 15 m | | VNIR bands imaged @ 15 m |
| | panchromatic | | compressed to 30 m |
| Geographic | <65 m circular error | <65 m circular error | <65 m circular error |
| Registration | | | |
| Band-band | Uncertainty <4.5 m | Uncertainty <0.15 | uncertainty <0.15 pixel |
| registration | (0.15 pixel) | pixel | VNIR, <0.28 SWIR |
| Geographic | All land areas between | All land areas | All land areas between ±81.2° |
| coverage | ±81.2° north and south | between ±81.2° | N and S latitudes via |
| | latitudes, including | north and south | “always on” imaging over |
| | islands, atolls, and | latitudes at least | sunlit land yielding much |
| | continental shelf | twice per year. | more coverage than LDCM |
| | regions of <50 m water | | |
| | depth. | | |

One performance driver for the TerEDyn instrument is a data solution which will meet the increased timeliness, imagery quality and amount of data available for scientific analysis. The TerEDyn swath width completes full Earth coverage at 30 m spatial resolution in 7 days, resulting in an 8-day (approximately 1 week) repeat of the orbit. The 390 km swath provides not only increased data repeat to facilitate acquisition and timeliness of generating cloud-free mosaics, but increases the volume of data needed for enhanced data products. In one embodiment, the TerEDyn instrument uses the RapidEye Three Mirror Anastigmat (TMA) Wide Field-Of-View (WFOV), EarthCARE SWIR detectors, the Disaster Monitoring Constellation (DMC) VNIR detectors and the UK-DMC-2 Very High Resolution Imaging (VHRI) electronics solution, all of which have either flown or have completed qualification testing. RapidEye AG is a German geospatial information provider focused on assisting in management decision-making through services based on their own Earth observation imagery. EarthCARE is an acronym standing for EARTH Clouds, Aerosols and Radiation Explorer, and the aims of the mission are to improve understanding of the cloud, radiative and aerosol processes that affect the Earth's climate. UK-DMC 2 is a British Earth imaging satellite which is operated by DMC International Imaging.

In one or embodiments, the TerEDyn instrument covers the refined Landsat Operational Land Imager (OLI) bands in Blue, Green, Red, NIR, and SWIR at a 30 m ground sample distance (GSD). The TerEDyn sensor actually acquires the four VNIR bands at 15 m resolution, but on-board processing prior to downlink will be applied to downsample the 15 m pixels to 30 m to match the SWIR band resolution. This provides a homogeneous dataset and reduces downlink data volume. The instrument is designed to be able to operate in a continuous “always on over sunlit land” mode with a thermally stable focal plane, and to minimize detector-to-detector variability induced by instrument noise and unaccounted gain, bias and linearity differences in detector response.

In one embodiment, 12 micron (μm) detectors are used on the VNIR focal plane for the Red, Green, Blue and NIR bands. There are 8,192 pixels in each detector with 4 detectors per band for a total of 16 detectors. The TerEDyn SWIR detectors that provide the 1.6 μm region data may use InGaAs photodiode array detectors that have a 16-detector array of 1,024 pixels at 25 microns. These detectors may require cooling from 0° to −20° C. to satisfy SNR requirements. A cooling solution using thermoelectric coolers (TECs) will provide required thermal stability and cooling. The heat that the TEC's generate will be sunk to a radiator facing deep space exterior to the imager Optical Tube Assembly (OTA) and detector pack housing. The detectors are positioned close to the cold face of the radiator such that parasitic heating is limited, and the radiator is positioned/baffled so there is no obscuration by a solar array or reflected earthshine. Achieving temperatures as cold as −55° C. by passive means is viable. No other components are believed to require this type of cooling.

The all-reflective single aperture imager is based on the heritage wide angle TMA telescope design which has been flown on TopSat and the five RapidEye spacecraft. This design accommodates all wavebands through a single aperture with two separate focal plane arrays using a dichroic mirror to split the optical path. The instrument electronics solutions are currently in orbit on two DMC spacecraft, UKDMC-2 and Deimos-1. All electronic components, including detectors, have flown in a low-earth orbit (LEO) radiation environment (<10 Krad) or will be radiation tested and qualified up to 20 Krad.

In one embodiment, the instrument electronics will use dual Field Programmable Gate Array (FPGA)-based controller printed circuit boards (PCB), a primary and redundant cold spare. Each PCB is a rad-hard high-reliability FPGA device, one-time-programmable which handles all interfaces to the platform, e.g., low voltage directional signaling (LVDS), controller area network (CAN), telemetry, tracking, and command (TTC) bus, precise positioning system (PPS) GPS Time reference, generates all detector and Analogue Digital Converter (ADC) timing signals, and implements thermal control and monitoring. There is no processor or software involved; the system works immediately on power-up. The back-plane connects the primary and redundant controller PCBs to the detectors with flexi-PCBs running individually to each focal plane and contains non-redundant components such as detector clock drivers. Housekeeping data will be provided from instrument control electronics to the platform via a CAN bus.

Electromagnetic Compatibility (EMC) is managed through filtering on input DC/DC converters, TEC drives, and heaters. Sensitive supplies and bias voltages are filtered using linear regulators and screening is applied to reduce X-Band susceptibility.

Thermal isolation from the platform consists of multi-layer insulation (MLI) wrapping around the instrument, using an atomic oxygen-resistant material and long, low-thermal-conductivity bi-pod flexure mounts attached to the main structure.

Focal plane power will be dissipated via radiators on the cold side of the spacecraft. Passive radiators in conjunction with TECs (SWIR detectors only), heat sinks and thermal links will be used to cool the focal plane assemblies. Radiators are sized with 20% dissipation margin for a temperature difference of 10° C. allowed across the radiator and the heat-sink-to-radiator links. The heat-sink temperature will be allowed to rise 10° C. during imaging.

In one or more embodiments, the TerEDyn spectral bands are spectrally matched to the corresponding Landsat operational land imager (OLI) bands. During pre-launch calibration, the entire FOV will be calibrated against a flat field. Then calibration may be performed with a monochromator beam to calibrate a set of pixels measured by a photometer and applied to the rest of the instrument FOV. This should limit banding, streaking and noise artifacts during on-orbit testing. SNR verification and radiometric calibration is carried out using a calibrated integrating sphere and spectro-radiometer. The thermal environment will be controlled to be the same as that on orbit with a nitrogen purge to minimize risk from condensation and icing. These pre-launch calibrations will ensure meeting an on-ground radiometric specification within 7% of the absolute radiometric radiance. Calibrations will be defined in collaboration with national standards agencies (NIST, NPL). In one or more embodiments, on-orbit cross-calibration will refine this ground-based process, and should result in 1-4% relative calibration to the LDCM OLI, depending on band, based on the imager achieving 1-4% of ETM+.

Pre-launch filter quality will be measured for spectral leakage. Determining the filter out-of-band leakage is important to ensuring that the vegetation indices can be computed accurately. The filter out-of-band leakage of filters used on Landsat 7 and LDCM has been negligible.

The instrument emphasis on geometric calibration is based on good pre-launch knowledge of the internal camera geometry (i.e., detector lines of sight relative to the optical axis). This will be measured precisely pre-launch to ensure good knowledge for use during later geometric calibration on orbit.

In one or more embodiments, the instrument data rate is 15.279 M pixels per second. With 10-bit analog to digital conversion, it converts to 152.79 Mbps. The instrument will be able to expose for up to 4.356 ms to obtain maximum signal under dark-scene conditions.

The data volume and data products are detailed below. With one focal plane, there will be 16,384 SWIR 30 m pixels across track. This results in a 450 km swath. However, in order to reduce edge distortion, only 13,312 pixels will be used to support a 390 km swath; such that there will be 32,768 30 m pixels in each VNIR band. The nominal VNIR pixel output at 15 m may be down sampled on board to match the 30 m SWIR pixel size in order to reduce the downlink data volume.

In one embodiment, to establish a nominal TerEDyn “scene” size, it was decided that the same number of “row” pixels will be included in the along-track direction to yield a 390 km north/south dimension “scene.” It should be noted that in order to accommodate this data volume, the system has additional on board storage using redundant 16 Gbyte High Speed Data Recorder (HSDR) along with redundant 128 Gbyte Flash Mass Memory Units (FMMU). In addition, JPEG-LS compression may be implemented. JPEG-LS is a simple and efficient algorithm which consists of two independent modeling and encoding stages using differential pulse code modulation (DPCM) operating on individual pixels without block formatting. It was developed to provide a low-complexity near-lossless image compression with better compression efficiency than lossless JPEG.

The compression factor is adjustable from the ground, which allows TerEDyn maximum flexibility in order to meet the scientific quality required. Using JPEG-LS compression (e=1), a single orbit of the uncompressed and the compressed data will use an average of 20% of the on board storage at any time. Reducing the compression factor (to e=0) to provide less compression (˜2.4 to 1) results in 107 Gbytes of storage required daily which is greater than a 58% increase in data storage usage.

In addition to raw data, and in one or more embodiments, the storage may include metadata generated in separate Geolocation Ancillary Files (GAFs). The GAFs contain GPS (PVT) and attitude (RPY) at a 10 s sample rate. In the ground processing, the GAFs are processed with image files such that there are 10 minutes of data before and after each image. Thus the orbit fit in the ground processing is based on a longer period and the orbit propagation is much longer, resulting in a higher level of geolocation accuracy. These files are small (˜kb size) and are not considered as a contributing factor to the overall usage of the on-board storage as they increase the overall usage by only 1-2%. Data downlink may occur daily at ground stations in both the northern and southern hemispheres.

In one or more embodiments, coincident underflights of OLI by TerEDyn will result from the difference in the two orbital altitudes (705 vs 615 km) which present numerous cross-calibration opportunities throughout the life of the mission. This novel approach presents a much better solution than the “one and done” cross-calibration of Landsat 5 and Landsat 7 (i.e., the orbital tracks of Landsat 5 and 7 were phased 8 days apart shortly after the 3-day underflight maneuver was performed early in the life of Landsat 7). Such techniques are believed to be capable of yielding radiometry that is within 1-4% of Landsat 7.

In one or more embodiments, TerEDyn may be placed into a sun-synchronous polar orbit at 615 km, 98° inclination with a 9:45 AM+/−15 minute Local Time of Descending Node (LTDN) crossing. During initial satellite commissioning, radiometric calibration may be performed using the pre-launch values as the starting baseline, and adjustments made via cross-calibration to LDCM OLI using several Pseudo-Invariant Calibrations Sites (PICS), such as the well-known Libya 4 site in the Saharan Desert, the Tuz Golu dry lake area of Turkey, the Sonoran Desert, and Dome-C in the Antarctic. Calibration checks over most PICS could be continued monthly, while an annual absolute calibration may be performed using the Tuz Golu site. Given the stability inherent in this approach, continuity of calibration with previous Landsat sensors (and archives) is ensured, even in the unlikely event that no Landsat sensor is operational during the TerEDyn mission.

An additional activity that may be performed during the commissioning period is a “side slither” yaw maneuver of the spacecraft to rotate the instrument 90° to the normal ground track so that the orientation of the detectors along track and across track is reversed temporarily. Seeing the same real estate on the ground from these orthogonal orientations will facilitate estimates of detector-to-detector relative gain and thereby improve our capability to reduce striping in the imagery. Also during satellite commissioning, on board JPEG-LS compression effects at the lower e-factors could be evaluated to ensure the highest quality science data is achieved within downlink volume constraints.

In one or more embodiments, satellite operations are planned to extend two years after instrument commissioning and data validation, although the spacecraft and instrument are capable of an extended mission life of 5-7 years due to flight proven heritage and high performance margins. The instrument duty cycle may be commanded to always capture images when over sunlit land, and command and control is via the Ames Research Center (ARC) Mission Operations Center (MOC). Using the selected optics, the VNIR meets the 30 m GSD for optimal vegetation detection from the chosen orbit altitude. The orbit design may place TerEDyn within 30 minutes of the LDCM and Landsat 7 orbits. A 390 km swath and 35° cross track FOV may be chosen in order to provide coverage of the entire Earth in 7 days without any gaps at that orbit to support the higher temporal repeat frequency of this mission.

In one or more embodiments, X-Band imagery data may be down linked at multiple LDCM-compatible ground stations. Data will be forwarded with low latency, e.g., with no more than 24 hours latency, from the ground stations to the USGS EROS Center where the Landsat data are currently being processed and LDCM is planned to be processed.

As mentioned above, the spacecraft may be placed in a 615 km sun synchronous ˜98° retrograde orbit with a 9:45 AM+/−15 minutes LTDN. This orbit places TerEDyn within 30 minutes of the LDCM and Landsat 7 orbits for schedule coordination with selected ground communications stations, and to maintain consistency with data products.

Mission scenarios have been simulated on this orbit, successfully demonstrating 8-day repeat coverage of all sunlit land mass, repeating ground tracks, ground station coverage with margin, and ability to meet the 25-year deorbit requirements without propulsion.

Data downlink has been planned using CCSDS compatible ground stations in Svalbard, Norway; Poker Flats, AK; Hartebeesthoek, South Africa; however detailed planning by the NASA Near Earth Network during Phase A may result in selection of other Near-Earth Network (NEN) stations for scheduling reasons. A ground station at Alice Springs, Australia may also be provided to TerEDyn. The EROS ground terminal in Sioux Falls, S.D. may be provided as part of EROS services.

In one or more embodiment, central on-board computer processing may be provided by one or more On-Board Computers (OBC), which may be based around the PowerPC 750FL Processor using 256 MB EDAC protected SDRAM and 2 MB of Non-Volatile MRAM. The heritage NigeriaSat-2 OBC750 is a high performance single-board spacecraft computer, designed for LEO applications. The primary computer may be backed up by a redundant OBC750.

The data storage solution may utilize two fully redundant data storage paths. The dual high-speed data recorders (HSDR) provide 16 Gbyte of storage with transfer to the dual 128 Gbyte flash mass memory units (FMMU). The HSDRs serve as a buffer for the FMMUs. This provides more than adequate available storage for the data rates encountered. The FMMU NAND flash write/erase limits maximum endurance is 13.7 PBytes, and the flash endurance is 0.26 PBytes based on a five year mission lifetime. Bad block memory management may be implemented and wear leveling may be addressed through linearization of the file system. This arrangement provides more than adequate storage for all sunlight imaging land mass coverage by TerEDyn.

The Flight Software communicates with other units via a controller area network (CAN) bus. The CAN bus is a resilient dual redundant high-speed serial bus which runs at 388 kbps. All subsystem units could have the ability to communicate as a node individually addressed on the Primary or Redundant CAN bus. The Redundant CAN bus is used in the event of an anomaly on the Primary CAN bus or in the rare case that one of the units is saturating the bus with traffic. The CAN bus is used for sending commands to subsystems and receiving acknowledgements; sending telemetry requests to subsystems and receiving telemetry data responses; and transferring files to units.

The Flight Software may be configured to perform the following functions:

Telemetry Monitoring—Designed to monitor critical telemetry points and take appropriate action should levels deviate outside limits

OBC Watchdog-Designed to monitor that OBC flight software is running, and to switch to a safe configuration if it fails.

AOCS FDIR—Designed to ensure that the spacecraft attitude remains stable and controlled to ensure the platform is power and thermally safe

Payload Control—Mission schedules are loaded where they are expanded to produce the platform and payload commands required to perform imaging.

All safety critical operations may be commanded via the onboard computer to ensure that mission operations are performed within the safe operating limits of the spacecraft. The spacecraft may be launched in a passive (power off) safe mode to ensure safety of the spacecraft. Disconnect from the launch adapter may then be used to activate a switch which powers-on the bus. Onboard receivers are then ready to receive commands.

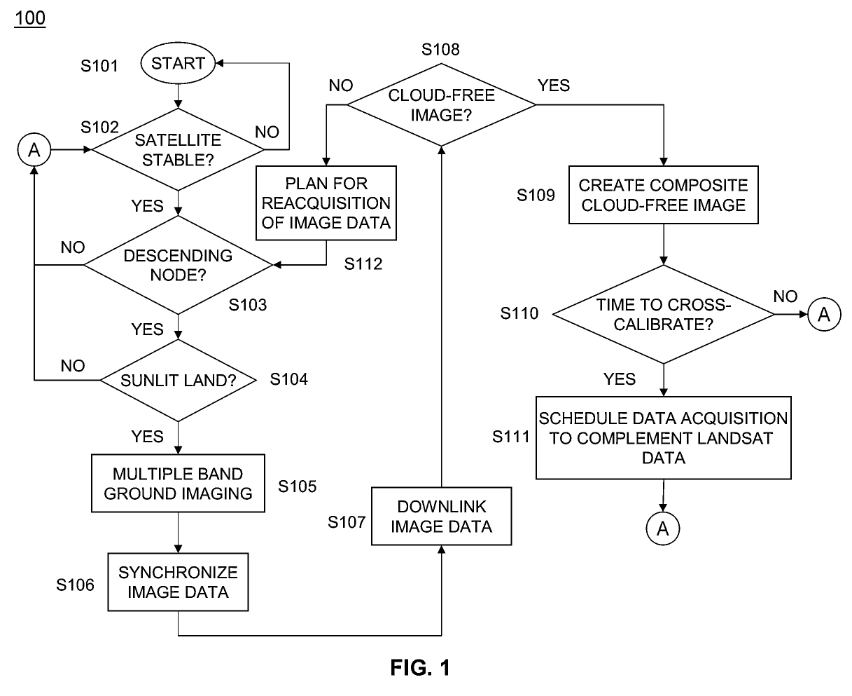

Turning now to FIG. 1, an embodiment of a method of this disclosure is illustrated in flowchart format. Process 100 starts at step S101, and then proceeds to step S102, where a determination is made as to the stability of the satellite. If stable, it is determined whether the satellite is in a descending node at step S103. If so, then processing continues to step S104, where a determination is made as to whether the satellite is over sunlit land. If neither of steps S103 and S104 are true, then processing returns to step S102. Once sunlit land is confirmed at step S104, multiple band imaging is carried out at step S105, e.g., multiple visible and IR bands, each with potentially different resolutions, e.g., 30 m and 15 m. When image data of different resolutions is obtained, the image data may be synchronized, i.e., higher resolution imagery may be reduced in resolution to match a lower resolution image, e.g., 15 m resolution images may be converted or “synchronized” to 30 m resolution at step S106. Image data is downlinked to a groundstation at step S107. If a cloud-free image is not achievable at step S108, reacquisition of image data is planned by determining when the satellite track will retrace over the cloud-covered area, and processing continues at step S103. The ability to accurately determine the time that the satellite will retrace or return to a previously-imaged area is made possible by careful selection of launch and orbital insertion parameters and reliance upon the pertinent orbital mechanics. After a cloud-free image is obtained or determined to be obtainable at step S108 (e.g., at a groundstation), a composite cloud-free image is created at step S109.

Depending on the time duration since the satellite image data has been correlated to the “gold standard” Landsat data, the cross-calibration or correlation of image data is scheduled at step S110 based upon the known and tightly controlled satellite track (discussed above) that either allows underflying a Landsat orbit or correlation with previously recorded Landsat data for known references geographic reference points. If it is not necessary or desired to cross-calibrate the image data with Landsat data at step S110, processing may return to the node labeled “A” in FIG. 1.

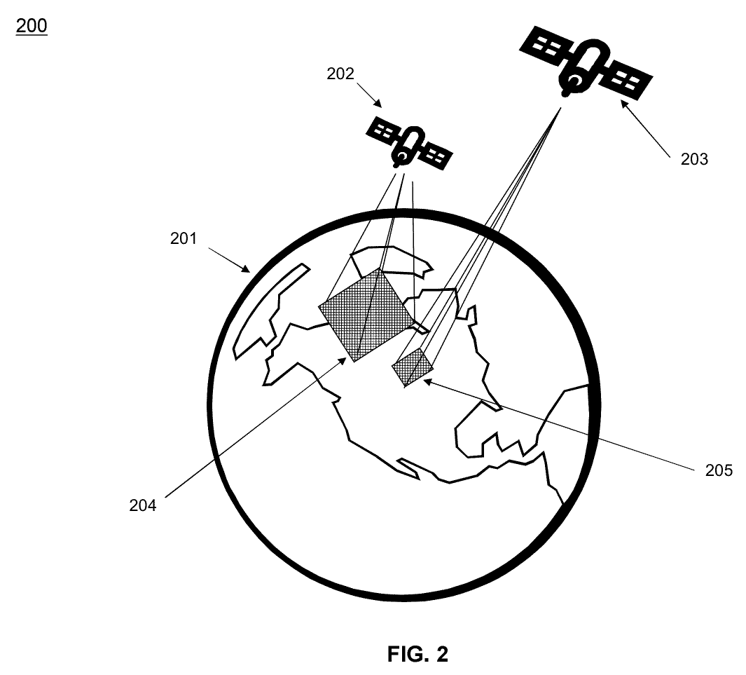

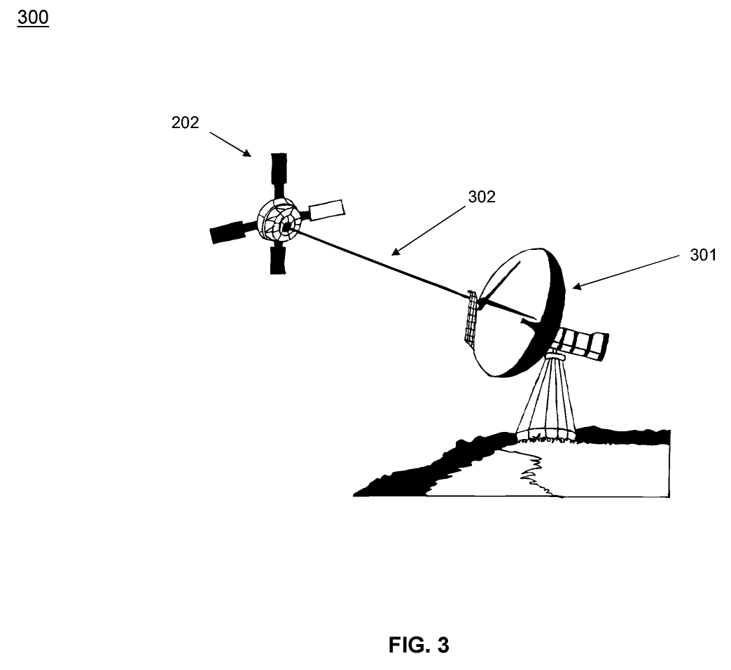

FIG. 2 illustrates space arrangement 200 including Earth 201, imaging satellite 202, Landsat 203, and the ground swaths 204 and 205 corresponding to imaging satellite 202 and Landsat 203, respectively. FIG. 2 makes the point that the imaged ground swath 204 of imaging satellite 202 is larger than the Landsat ground swath 205. FIG. 3, illustrates a downlink arrangement which includes imaging satellite 202, downlink 302, and ground station 301.

FIG. 7A provides an illustration of a satellite of an embodiment, e.g., the TerEDyn spacecraft and instrumentation characteristics, which may be an adaptation of a Surrey SSTL-150 spacecraft, for example. FIG. 7B provides an exemplary illustration of an enlarged ray tracing of wavelength paths for the instrument of FIG. 7A.

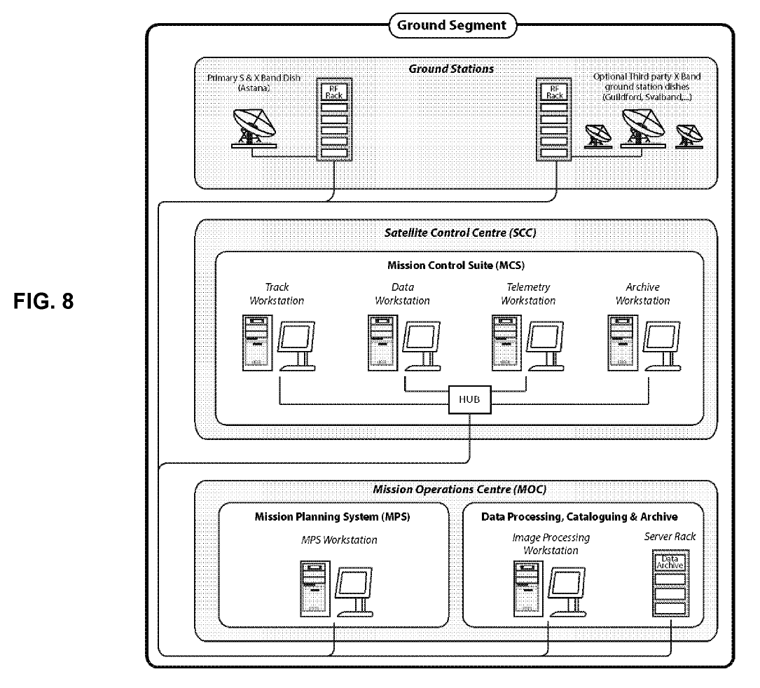

Finally, FIG. 8 illustrates an exemplary embodiment of a ground segment that may include ground station 301 of FIG. 3.

Those with skill in the art will appreciate that the inventive concept described herein may work with various system configurations. In addition, various embodiments of this disclosure may be implemented in hardware, firmware, software, or any suitable combination thereof. Aspects of this disclosure may also be implemented as instructions stored on a non-transitory machine-readable medium, which may be read and executed by one or more processors. A machine-readable medium may include any mechanism for storing information in a form readable by a machine (e.g., a computing device), and may include a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

In addition, the method of this disclosure is discussed in embodiments herein in functional terms that may be carried out in computer-implemented system by various “modules” having identified functional attributes. As would be appreciated by a person with skill in the art, these various modules may be implemented by one or more specially programmed processors that carry out various functions defined by, for example, the flow charts/algorithms described herein, as well as the functional objectives/requirements defined by the various tables in the Appendix to this disclosure.

The term “comprising” (and its grammatical variations) as used herein is used in the inclusive sense of “including” or “having” and not in the exclusive sense of “consisting only of”.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A method for augmenting Landsat-based image data, the method comprising:
providing a satellite at an orbital altitude lower than an orbital altitude of a Landsat imaging satellite;
providing a set of multispectral imaging devices arranged on the satellite, said set of multispectral imaging devices configured to image a terrestrial swath larger than a standard Landsat image swath, said set of multispectral imaging devices being configured to always image when orbiting over cloud-free terrestrial surfaces and to image on a descending node defined along a northeast to southwest trajectory so as to correspond to Landsat archive data;
synchronizing image data from at least four visible bands and a near-infrared band with 15 meter resolution with image data from a shortwave infrared band with 30 meter resolution;
retracing the imaged terrestrial swath for one or more iterations;
downlinking image data to a ground station, the downlinked image data being formatted in accordance with a Consultative Committee for Space Data Systems (CCSDS) data format;
compositing the synchronized image data to create a cloud-free image; and
periodically cross-calibrating the composited image data with Landsat-based image data.

2. A method for earth imaging, the method comprising:
providing a satellite at an orbital altitude that underflies an orbital altitude of a Landsat imaging satellite;
providing a set of multispectral imagers arranged on the satellite and covering a first plurality of visible bands and a second plurality of infrared bands that image a ground swath;
said first plurality of visible bands being imaged at a first resolution, and at least one of the second plurality of infrared bands being imaged at a second resolution different from the first resolution,
synchronizing image data from the first plurality of visible bands and a near infrared band with the first resolution with image data from the shortwave infrared band with the second resolution; and
downlinking image data to a ground station.

3. The method of claim 2, further comprising:
controlling the satellite to retrace the imaged ground swath one or more times; and
periodically cross-calibrating the image data with Landsat image data.

4. The method of claim 3, wherein said periodic cross-calibrating of the image data with Landsat image data improves a quality of the image data.

5. The method of claim 2, wherein said set of multispectral imagers are configured to image on a descending node from the northeast to the southwest so as to match a direction of Landsat image data.

6. The method of claim 2, further comprising compositing the synchronized image data to create a cloud-free image.

7. The method of claim 6, wherein the cloud-free image is created at least on a biweekly basis.

8. The method of claim 7, wherein the cloud-free image is created at least on about a weekly basis.

9. The method of claim 2, wherein the first and second resolutions are selectable via a command upload from the ground station.

10. The method of claim 2, further comprising using the downlinked image data to fill in temporal gaps in Landsat image data.

11. The method of claim 2, wherein said set of multispectral imagers are configured to image only when orbiting over sunlit land.

12. The method of claim 2, wherein said first resolution is 15 m, and said second resolution is 30 m.

13. The method of claim 12, wherein at least a portion of image data with 15 m resolution is converted to image data with 30 m resolution so as to reduce a data size of the image data downlinked to the ground station.

14. The method of claim 2, wherein said orbital altitude is approximately 615 km.

15. The method of claim 14, wherein said orbital altitude of the Landsat imaging satellite is approximately 705 km.

16. The method of claim 2, wherein the Landsat image data is archived Landsat data.
